(19) United States
(12) Patent Application Publication
(10) Pub. No.: US 2026/0034667 A1
(43) Pub. Date: Feb. 5, 2026

(54) ROBOT, TRAINING DATA COLLECTION METHOD, AND RECORDING MEDIUM

(71) Applicant: CASIO COMPUTER CO., LTD., Tokyo (JP)

(72) Inventors: Kouki MAYUZUMI, Tokyo (JP); Hirokazu HASEGAWA, Tokyo (JP)

(73) Assignee: CASIO COMPUTER CO., LTD., Tokyo (JP)

(21) Appl. No.: 19/245,949

(22) Filed: Jun. 23, 2025

(30) Foreign Application Priority Data
Aug. 1, 2024 (JP) 2024-126218

(51) Int. Cl. B25J 9/16

(52) U.S. Cl. CPC B25J 9/163; B25J 9/1694

(57) ABSTRACT

A robot includes a sensor that detects an external stimulus, and at least one processor. In response to detection, by the sensor and as the external stimulus, of a sound that satisfies a predetermined collection condition, the at least one processor stores sound data expressing the detected sound in a storage device as training data for identifying a speaker from the sound, and in response to detection by the sensor of an external stimulus that satisfies a specific condition, the at least one processor changes the collection condition such that the sound detected by the sensor more easily satisfies the collection condition for a period from the detection of the external stimulus satisfying the specific condition until a predetermined amount of time elapses.

### CROSS-REFERENCE TO RELATED APPLICATIONS

This application is based upon and claims the benefit of priority under 35 USC 119 of Japanese Patent Application No. 2024-126218, filed on Aug. 1, 2024, the entire disclosure of which, including the description, claims, drawings, and abstract, is incorporated herein by reference in its entirety.

### FIELD OF THE INVENTION

This application relates generally to a robot, a training data collection method, and a recording medium.

### BACKGROUND OF THE INVENTION

Robots that imitate living creatures are known in the related art. For example, International Publication No. WO2019/181144 describes a pet-type robot wherein information about the face and voice of a user is trained in advance, and the robot performs different behaviors for each user by identifying the user. In particular, International Publication No. WO2019/181144 indicates that, in order to efficiently collect the information used for user identification, a robot device performs an action for collecting sound data from users for which sound data is insufficient.

### SUMMARY OF THE INVENTION

A robot according to an embodiment of the present disclosure includes: a sensor for detecting an external stimulus; and at least one processor, wherein, in response to detection, by the sensor and as the external stimulus, of a sound that satisfies a predetermined collection condition, the at least one processor stores sound data expressing the detected sound in a storage device as training data for identifying a speaker from the sound, and in response to detection by the sensor of an external stimulus that satisfies a specific condition, the at least one processor changes the collection condition such that the sound detected by the sensor more easily satisfies the collection condition for a period from the detection of the external stimulus satisfying the specific condition until a predetermined amount of time elapses.

### BRIEF DESCRIPTION OF DRAWINGS

A more complete understanding of this application can be obtained when the following detailed description is considered in conjunction with the following drawings, in which:

FIG. 1 is a drawing illustrating the appearance of a robot according to Embodiment 1;

FIG. 2 is a cross-sectional view of the robot according to Embodiment 1, viewed from the side;

FIG. 3 is a block diagram illustrating the functional configuration of the robot according to Embodiment 1;

FIG. 4 is a drawing illustrating an example of an event table according to Embodiment 1;

FIG. 5 is a drawing illustrating an example of training data according to Embodiment 1;

FIG. 6 is a drawing illustrating an example in which sound data is classified into a plurality of groups in Embodiment 1;

FIG. 7 is a flowchart illustrating the flow of robot control processing according to Embodiment 1;

FIG. 8 is a flowchart illustrating the flow of data collection processing according to Embodiment 1; and

FIG. 9 is a block diagram illustrating the functional configuration of a data collection device according to Embodiment 2.

### DETAILED DESCRIPTION OF THE INVENTION

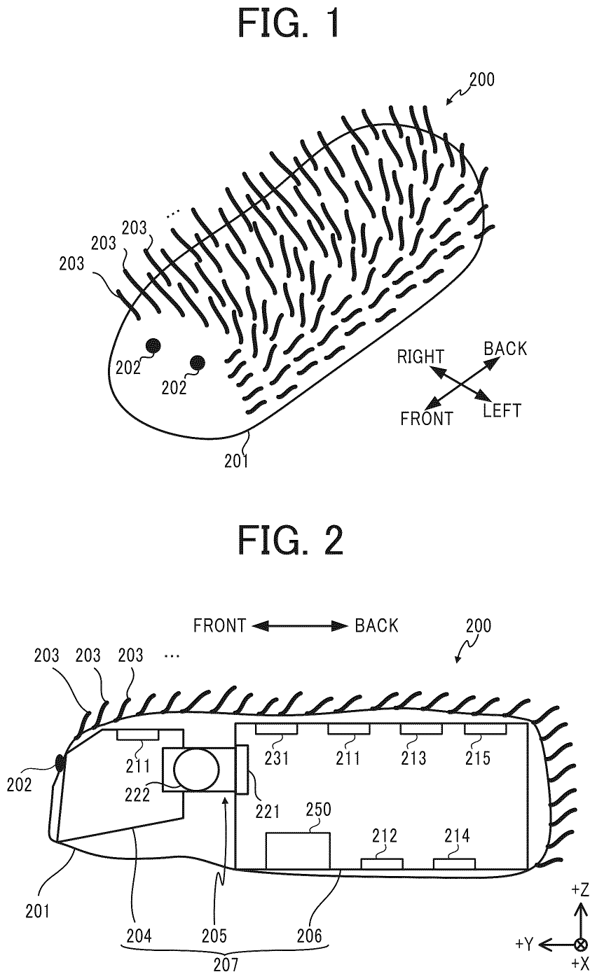

Hereinafter, embodiments of the present disclosure are described while referencing the drawings. Note that, in the drawings, identical or corresponding components are denoted with the same reference numerals. A robot 200 according to Embodiment 1 is a device that imitates a living creature and that can pseudo-express various states of that living creature. In particular, the robot 200 according to Embodiment 1 is a pet-type robot that is capable of identifying the voice of a specific user, such as a pseudo-owner. In one example, as illustrated in FIG. 1, the robot 200 according to Embodiment 1 is a pet robot that resembles a small animal. The robot 200 includes an exterior 201 provided with bushy fur 203 and decorative parts 202 resembling eyes. As illustrated in FIG. 2, the robot 200 includes a housing 207. The housing 207 is covered by the exterior 201, and is accommodated inside the exterior 201. The housing 207 includes a head 204, a coupler 205, and a torso 206. The coupler 205 couples the head 204 to the torso 206.

The exterior 201 is an example of an exterior member, and has the shape of a bag that is long in a front-back direction and capable of accommodating the housing 207 therein. The exterior 201 is formed in a barrel shape from the head 204 to the torso 206, and integrally covers the torso 206 and the head 204. Due to the exterior 201 having such a shape, the robot 200 is formed in a shape as if lying on its belly. An outer material of the exterior 201 simulates the feel to touch of a small animal, and is formed from an artificial pile fabric that resembles the fur 203 of a small animal. A backing material of the exterior 201 is formed from such a flexible material such as leather or rubber. The backing material is formed from such the flexible material and, as such the exterior 201 conforms to the movement of the housing 207. Specifically, the exterior 201 conforms to the rotation of the head 204 relative to the torso 206.

The torso 206 extends in the front-back direction, and contacts, via the exterior 201, a placement surface such as a floor, a table, or the like on which the robot 200 is placed. The torso 206 includes a twist motor 221 at a front end thereof. The head 204 is coupled to the front end of the torso 206 via the coupler 205. The coupler 205 includes a vertical motor 222. Note that, in FIG. 2, the twist motor 221 is provided on the torso 206, but may be provided on the coupler 205. Due to the twist motor 221 and the vertical motor 222, the head 204 is coupled to the torso 206 so as to be rotatable, around a left-right direction (X-axis direction) and the front-back direction (Y-axis direction) of the robot 200, with respect to the torso 206.

The coupler 205 couples the torso 206 and the head 204 so as to enable rotation around a first rotational axis that passes through the coupler 205 and extends in the front-back direction (the Y-axis direction) of the torso 206. The twist motor 221 is a servo motor for rotating the head 204, with respect to the torso 206, clockwise (right rotation) (forward rotation) and counter-clockwise (left rotation) (reverse rotation) around the first rotational axis. Additionally, the coupler 205 couples the torso 206 and the head 204 so as to enable rotation around a second rotational axis that passes through the coupler 205 and extends in the left-right direction (the X-axis direction) of the torso 206. The vertical motor 222 is a servo motor for rotating the head 204 upward (forward rotation) and downward (reverse rotation) around the second rotational axis.

The robot 200 includes a touch sensor 211 on the head 204 and the torso 206. Additionally, the robot 200 includes, on the torso 206, an acceleration sensor 212, a microphone 213, a gyrosensor 214, an illuminance sensor 215, a speaker 231, a battery 250, and a communicator 260. Note that, at least a portion of the acceleration sensor 212, the microphone 213, the gyrosensor 214, the illuminance sensor 215, and the speaker 231 is not limited to being provided on the torso 206 and may be provided on the head 204, or may be provided on both the torso 206 and the head 204.

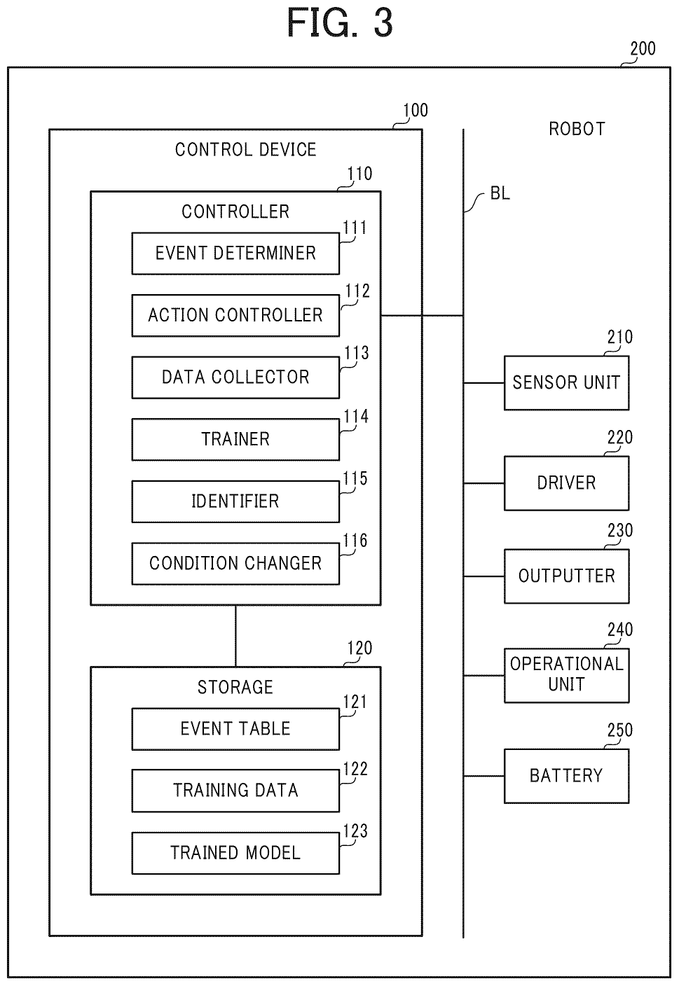

Next, the functional configuration of the robot 200 is described while referencing FIG. 3.

As illustrated in FIG. 3, the robot 200 includes a control device 100, a sensor unit 210, a driver 220, an outputter 230, and an operational unit 240. In one example, these various components are connected via a bus line BL. Note that a configuration is possible in which, instead of the bus line BL, a wired interface such as a universal serial bus (USB) cable or the like, or a wireless interface such as Bluetooth (registered trademark) or the like is used.

The control device 100 includes a controller 110 that is an example of a controller, and a storage 120 that is an example of a storage device. The control device 100 controls the actions of the robot 200 by the controller 110 and the storage 120. The controller 110 includes a central processing unit (CPU). In one example, the CPU is a microprocessor or the like and is a central processing unit that executes a variety of processing and computations. In the controller 110, the CPU reads out a control program stored in the ROM and controls the actions of entire device (the robot 200) while using the RAM as working memory. Additionally, while not illustrated in the drawings, the controller 110 is provided with a clock function, a timer function, and the like, and can measure the date and time, and the like. The controller 110 may also be called a “processor.”

The storage 120 includes read-only memory (ROM), random access memory (RAM), flash memory, and the like. The storage 120 stores an operating system (OS), application programs, and other programs and data used by the controller 110 to perform the various processes. Moreover, the storage 120 stores data generated or acquired as a result of the controller 110 performing the various processes. Specifically, the storage 120 stores an event table 121, training data 122, and a trained model 123. These are described in detail later.

The sensor unit 210 includes the touch sensor 211, the acceleration sensor 212, the microphone 213, the gyrosensor 214, and the illuminance sensor 215 described above. The controller 110 acquires, via the bus line BL, detection values detected by the various sensors of the sensor unit 210. Note that the sensor unit 210 may include sensors other than those described above. The types of external stimuli acquirable by the controller 110 can be increased by increasing the types of sensors of the sensor unit 210.

The touch sensor 211 includes, for example, a pressure sensor and a capacitance sensor, and detects the presence/absence of a contact of some sort of object, and the strength of that contact. The controller 110 can detect, on the basis of the detection values of the touch sensor 211, petting or striking of the head 204 or the torso 206 by the user.

The acceleration sensor 212 detects an acceleration applied to the torso 206 of the robot 200. The gyrosensor 214 detects an angular velocity that is applied to the torso 206 of the robot 200. The controller 110 can detect, by the acceleration sensor 212 and the gyrosensor 214, the current attitude and changes in the attitude of the robot 200. Additionally, by using the acceleration sensor 212 and the gyrosensor 214, the controller 110 can detect that the user has picked up the robot 200, changed the orientation of the robot 200, thrown the robot 200, and the like.

The microphone 213 detects ambient sound of the robot 200. For example, the controller 110 detects, on the basis of a component of the sound detected by the microphone 213, the voice of a person such as, for example, speaking of the user to the robot 200. Additionally, the controller 110 detects, on the basis of a component of the sound detected by the microphone 213, sounds other than the voice of a person. Examples of the sounds other than the voice of a person include the sound of the user clapping their hands, environmental sounds, sudden sounds, and the like that occur around the robot 200. Note that the touch sensor 211, the acceleration sensor 212, the microphone 213, and the gyrosensor 214, of the sensor unit 210 are examples of an external stimulus detection device that detects the external stimulus.

The illuminance sensor 215 detects the illuminance of the surroundings of the robot 200. The controller 110 can detect that the surroundings of the robot 200 have become brighter or darker on the basis of the illuminance detected by the illuminance sensor 215.

The driver 220 includes the twist motor 221 and the vertical motor 222 described above, and is driven by the controller 110. The robot 200 can express actions of turning the head 204 to the side by using the twist motor 221, and can express actions of lifting/lowering the head 204 by using the vertical motor 222. The outputter 230 includes the speaker 231, and sound is output from the speaker 231 as a result of sound data being input into the outputter 230 by the controller 110. For example, the robot 200 emits a pseudo-animal sound as a result of the controller 110 inputting animal sound data of the robot 200 into the outputter 230. Note that, instead of or in addition to the speaker 231, a display, a light emitting diode (LED) or the like may be provided as the outputter 230. The operational unit 240 includes an operation button, a volume knob, or the like. In one example, the operational unit 240 is an interface for receiving user operations such as turning the power ON/OFF, adjusting the volume of the output sound, and the like. The battery 250 stores power to be used in the robot 200. Upon return of the robot 200 to a charging station, the battery 250 is charged by the charging station.

Next, the functional configuration of the controller 110 is described. As illustrated in FIG. 3, the controller 110 functionally includes an event determiner 111 that is an example of an event determination device, an action controller 112 that is an example of an action control device, a data collector 113 that is an example of a data collection device, a trainer 114 that is an example of a training device, an identifier 115 that is an example of an identification device, and a condition changer 116 that is an example of a condition changing device. In the controller 110, the CPU performs control and reads the program stored in the ROM out to the RAM and executes that program, thereby functioning as the various components described above.

The event determiner 111 determines whether an event based on the external stimulus detected by the sensor unit 210 has occurred. Here, the external stimulus is a stimulus that acts on the robot 200 from outside the robot 200. Specific examples of the external stimulus include a contact detected by the touch sensor 211, an acceleration detected by the acceleration sensor 212, a sound detected by the microphone 213, an angular velocity detected by the gyrosensor 214, and combinations thereof.

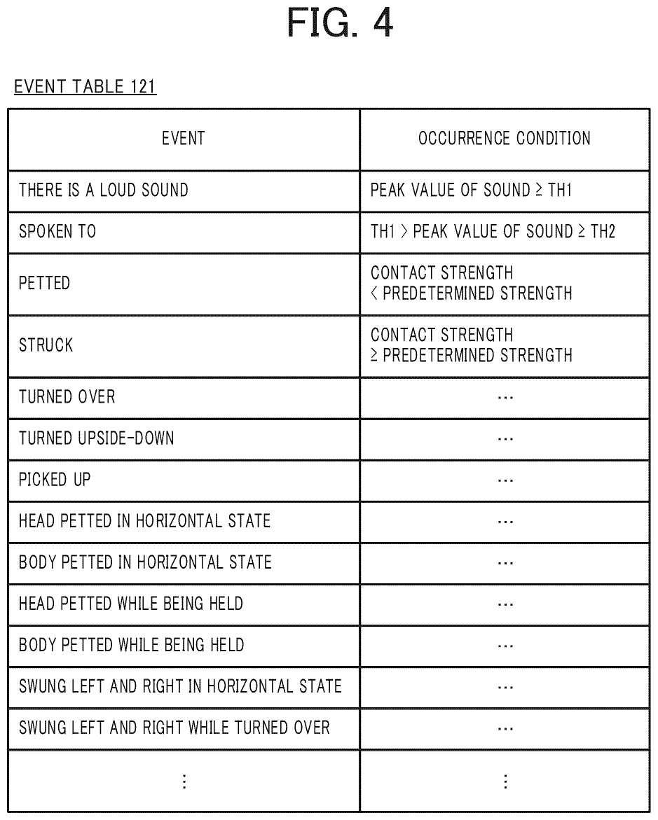

The event determiner 111 determines whether any of the plurality of events defined in the event table 121 have occurred on the basis of the detection values of the touch sensor 211, the acceleration sensor 212, the microphone 213, and the gyrosensor 214 of the sensor unit 210. The event table 121 is a table that defines a plurality of events that may possibly occur for the robot 200, and an occurrence condition for each of the events. In one example, as illustrated in FIG. 4, the event table 121 defines events such as “there is a loud sound”, “spoken to”, “petted”, “struck”, “turned over”, and the like.

The event determiner 111 references the event table 121 to determine whether the detection value of the external stimulus from the sensor unit 210 satisfies the occurrence condition of any of the events. For example, in a case in which a sound is detected by the microphone 213 that has a peak value greater than or equal to a first threshold TH1, the event determiner 111 determines that the event “there is a loud sound” has occurred. In a case in which a sound is detected by the microphone 213 that has a peak value less than the first threshold TH1 and greater than or equal to a second threshold TH2, the event determiner 111 determines that the event “spoken to” has occurred. In a case in which a contact of less than a predetermined strength is detected by the touch sensor 211 of the head 204 or the torso 206, the event determiner 111 determines that the “petted” event has occurred. In a case in which a contact greater than or equal to the predetermined strength is detected by the touch sensor 211 of the head 204 or the torso 206, the event determiner 111 determines that the event “struck” has occurred.

Note that the occurrence condition is not limited to the detection value of a single sensor, and may be defined by a combination of the detection values of a plurality of sensors of the sensor unit 210. For example, the event “head petted in horizontal state” is defined by the detection values of the touch sensor 211 of the head 204, the acceleration sensor 212, and the gyrosensor 214. Thus, the event determiner 111 determines, on the basis of the external stimulus detected by the sensor unit 210, whether the occurrence condition of any of the events defined in the event table 121 has been met, and in a case in which the occurrence condition of one of the events has been met, determines that the corresponding event has occurred.

The action controller 112 controls the actions of the robot 200. Here, the actions of the robot 200 are realized by one or both of motion by the driver 220 and output by the outputter 230. Specifically, the motion by the driver 220 corresponds to rotating the head 204 by the driving of the twist motor 221 or the vertical motor 222. The output of the outputter 230 corresponds to outputting an animal sound from the speaker 231 or causing the LED to emit light. The actions of the robot 200 may also be called a gesture, a behavior, or the like of the robot 200.

In response to detection of an external stimulus by the sensor unit 210, the action controller 112 causes the robot 200 to act in accordance with the detected external stimulus. More specifically, upon determination by the event determiner 111 that any of the events has occurred, the action controller 112 causes the robot 200 to execute a corresponding action that corresponds to the event that occurred. For example, in the case of “there is a loud sound”, the action controller 112 causes the robot 200 to execute a surprised action. In the case of “spoken to”, the action controller 112 causes the robot 200 to execute an action of reacting to being spoken to. In the case of “turned over”, the action controller 112 causes the robot 200 to execute an action expressing an unpleasant reaction. In the case of “petted”, the action controller 112 causes the robot 200 to execute a happy action. In the case of “struck”, the action controller 112 causes the robot 200 to execute a sad action.

Correspondence between the events and the corresponding actions is not illustrated in the drawings, but is stored in advance as an action table in the storage 120. The action table defines, for every event and as the corresponding action, a rotation amount and rotation direction of the twist motor 221, a rotation amount and a rotation direction of the vertical motor 222, and a type and output volume of the animal sound output from the speaker 231. The action controller 112 references the action table to cause the robot 200 to executed the corresponding action that corresponds to the event that occurred.

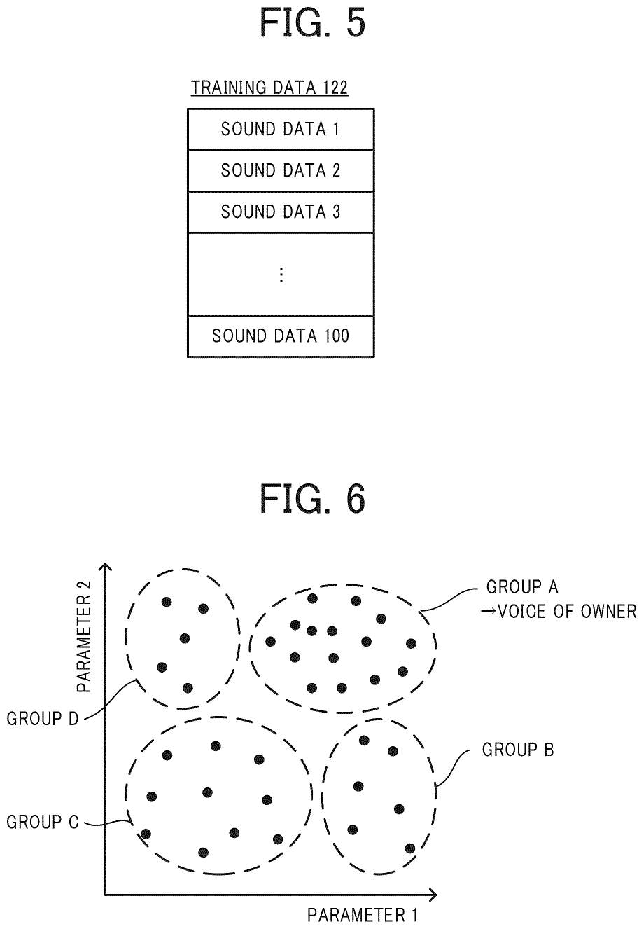

Returning to FIG. 3, the data collector 113 collects the training data 122. Here, the training data 122 is training data for machine learning for identifying a speaker from the voice of that speaker. As described in detail later, the training data 122 is data for generating a trained model 123 by the trainer 114 executing machine learning. As illustrated in FIG. 5, the training data 122 includes a plurality of sets of sound data. In FIG. 5, a case in which the training data 122 includes sound data 1 to 100 is illustrated as one example.

The data collector 113 determines whether some sort of sound such as the voice of the user, the sound of the user clapping their hands, environmental sounds, sudden sounds, and the like is detected by the microphone 213 of the sensor unit 210 as the external stimulus. In a case in which some sort of sound is detected by the microphone 213, the data collector 113 determines whether a feature of the detected sound satisfies a predetermined collection condition. Here, the collection condition is a condition for collecting the training data 122, and is a condition set in advance such that sound data suitable as the training data 122 is more easily collected from among the sounds detected by the microphone 213.

Specifically, the collection condition is satisfied in a case in which the peak value of the sound detected by the microphone 213 is less than or equal to the first threshold TH1 and also is greater than or equal to the second threshold TH2, and furthermore, at least one feature quantity of the sound detected by the microphone 213 is greater than or equal to a third threshold TH3. Here, the term “peak value of the sound” means the maximum value of the volume.

The first threshold TH1 is a threshold for determining whether the detected sound is a “loud sound.” In a case in which the peak value of the sound detected by the microphone 213 is greater than or equal to the first threshold TH1, the data collector 113 determines that the detected sound corresponds to “loud sound.” Here, “loud sound” corresponds to a sound that is louder than the speaking voice of a person, such as, for example, the sound of clapping hands, noise, or the like. The first threshold TH1 is set to a value greater than the typical volume of the speaking voice of a person so as to make it possible to determine such a “loud sound.”

In contrast, the second threshold TH2 is a threshold for determining whether the detected sound is the voice of a person. In a case in which the peak value of the sound detected by the microphone 213 is less than the first threshold TH1 and, also, is greater than or equal to the second threshold TH2, the data collector 113 determines that the detected sound corresponds to a voice. The second threshold TH2 is set to a value less than the first threshold TH1 and smaller than the typical volume of the speaking voice of a person. Meanwhile, in a case in which the peak value of the sound detected by the microphone 213 is less than the second threshold TH2, the data collector 113 determines that the detected sound does not correspond to “loud sound” and is another sound such as an environmental sound or the like.

The third threshold TH3 is a threshold for determining whether the detected sound is a voice suitable as the training data 122. The voice suitable as the training data 122 is a voice whereby the speaker of that voice can be accurately identified, and in which a feature clearly appears. In a case in which the peak value of the sound detected by the microphone 213 is less than the first threshold TH1 and, also, is greater than or equal to the second threshold TH2, the data collector 113 further determines whether at least one feature quantity of the detected sound is greater than or equal to the third threshold TH3.

Specifically, the data collector 113 acquires, as feature quantities of the detected sound, the peak value of the detected sound and a deviation of the detected sound. The deviation of the sound is the difference with a reference value such as the mean, median, mode, or the like. Upon acquisition of the peak value and the deviation, the data collector 113 determines whether the peak value is greater than or equal to a peak threshold TH3_1 and, also, whether the deviation is greater than or equal to a deviation threshold TH3_2. The peak threshold TH3_1 is a value between the first threshold TH1 and the second threshold TH2. The peak threshold TH3_1 and the deviation threshold TH3_2 are specific examples of the third threshold TH3. Note that the data collector 113 is not limited to acquiring the peak value or the deviation as the feature quantity of the sound collected by the microphone 213, and may acquire other feature quantities such as a change over time of a frequency component.

Upon determination that the peak value is greater than or equal to the peak threshold TH3_1 and, also, the deviation is greater than or equal to the deviation threshold TH3_2, the data collector 113 determines that the detected sound satisfies the collection condition. In this case, the data collector 113 determines that the sound detected by the microphone 213 is a voice suitable as the training data 122. Moreover, the data collector 113 stores sound data expressing the detected sound in the storage 120 as the training data 122. For example, as illustrated in FIG. 5, in a case in which the training data 122 includes a plurality of sets of sound data 1 to 100, the data collector 113 adds the sound data expressing the newly detected sound to the training data 122 as new sound data 101.

In contrast, in a case in which the peak value is less than the peak threshold TH3_1 or the deviation is less than the deviation threshold TH3_2, the detected sound does not satisfy the collection condition. In such a case, the data collector 113 determines that the sound detected by the microphone 213 is not a voice suitable as the training data 122. The data collector 113 does not store the sound data expressing the detected sound in the storage 120 as the training data 122. Thus, the data collector 113 stores, in the storage 120 and as the training data 122, sound data expressing sounds that satisfy the predetermined collection condition among the sounds detected by the microphone 213.

Returning to FIG. 3, the trainer 114 performs machine learning on the basis of the training data 122 collected by the data collector 113, and generates a trained model 123. The trained model 123 is a model for identifying the speaker of a voice from the corresponding voice. More specifically, the trained model 123 is a model for receiving the input of sound data and identifying, from the features of that sound data, if the speaker of the voice is a specific user corresponding to the owner, or is a different user.

The trainer 114 performs the machine learning by using the clustering method, which is a type of teacher-less training. Here, “clustering” is a method for classifying data sets into a plurality of groups on the basis of specific rules. The trainer 114 classifies the plurality of sets of sound data included in the training data 122 into a plurality of groups using a known clustering method such as the k-means method (k-averaging method) or Ward's method.

More specifically, the trainer 114 extracts a plurality of parameters expressing the features of the sounds from each of the plurality of sets of sound data included in the training data 122. Moreover, as illustrated in FIG. 6, the trainer 114 maps the plurality of sets of sound data on the basis of the plurality of parameters. In FIG. 6, one data point corresponds to one piece of sound data. The trainer 114 classifies, on the basis of similarity of the plurality of parameters, sound data that have high similarity to the same group, thereby classifying the plurality of sets of sound data into a plurality of groups (groups A to D in the example illustrated in FIG. 6).

Parameters used in known voice recognition technology can be used as the plurality of parameters extracted from the sound data. In one example, the trainer 114 performs fast Fourier transform on each of the plurality of sets of sound data included in the training data 122. The trainer 114 can use the Fourier coefficients of the plurality of frequency components thereby obtained as the parameters. Note that, in FIG. 6, to facilitate comprehension, two parameters, namely parameter 1 and parameter 2, are used, but this is merely an example and it is preferable to use a greater number of parameters in order to increase identification accuracy.

The trainer 114 classifies performs the machine learning using such a clustering method to classify the plurality of sets of sound data included in the training data 122 into a plurality of groups. As a result, the trainer 114 generates a trained model 123 that outputs, in response to the input of a voice, information about the group to which that voice belongs. Note that the trainer 114 performs the machine learning using such a clustering method in response to the number of pieces of data of the training data 122 collected by the data collector 113 being greater than or equal to a reference value, and generates the trained model 123. Here, the number of pieces of data of the training data 122 is the number of pieces of sound data included in the training data 122. In cases in which the number of pieces of data of the training data 122 is low, it is not possible to perform effective machine learning and, consequently, it is difficult to generate a trained model 123 whereby it is possible to accurately identify a speaker. As such, the trainer 114 does not perform the machine learning until the number of pieces of data of the training data 122 is greater than or equal to a predetermined reference value, and performs the machine learning after a sufficient number of pieces of the sound data has been collected by the data collector 113.

Returning to FIG. 3, in response to detection by the sensor unit 210 of a voice as the external stimulus, the identifier 115 identifies the speaker of the detected voice using the trained model 123 generated by the trainer 114. Specifically, in a case in which a voice is detected by the microphone 213 and, also, the detected voice satisfies the collection condition, sound data expressing the detected voice is input into the trained model 123. As output for the inputted sound data, the trained model 123 outputs information expressing the group that the voice of the inputted sound data has the highest possibility of belonging to among the plurality of groups classified by the clustering. The identifier 115 identifies, as the speaker of the detected voice, the speaker corresponding to the group expressed in the information output form the trained model 123.

More specifically, the identifier 115 identifies whether the speaker of the detected voice is the specific user corresponding to the pseudo-owner of the robot 200. The pseudo-owner of the robot 200 (hereinafter referred to simply as “the owner”) is the user corresponding to the owner of a pet and, in one example, is the owner, manager, or the like of the robot 200. The owner is often near the robot 200 and, as such, it is anticipated that the owner has more opportunities to speak to the robot 200 than other users. As such, the identifier 115 determines the group for which the number of pieces of data is the greatest, among the plurality of groups classified by the clustering, to be the group of sound data of the owner. Specifically, in the example of FIG. 6, the identifier 115 determines that group A among groups A to D is the group of the sound data of the pseudo-owner.

Thus, in cases in which the group expressed in the information output from the trained model 123 is the group for which the number of pieces of data is greatest, the identifier 115 identifies the speaker of the detected voice as the specific user corresponding to the owner. In contrast, in cases in which the group expressed in the information output from the trained model 123 is a group other than the group for which the number of pieces of data is greatest, the identifier 115 identifies the speaker of the detected voice as a user other than the owner.

In response to the speaker being identified by the identifier 115 as the specific user, the action controller 112 causes the robot 200 to execute an action that is different than an action to be executed in response to the speaker being identified by the identifier 115 as a user other than the specific user. In other words, the action controller 112 causes the robot 200 to perform different actions as the corresponding action that corresponds to “spoken to” in the event table 121 illustrated in FIG. 4 for cases in which the speaker is and is not the specific user corresponding to the owner.

Specifically, cases in which the speaker is identified by the identifier 115 as not being the specific user correspond to cases in which the robot 200 is spoken to by a user other than the owner. In such cases, the action controller 112 causes the robot 200 to execute an action of reacting to being spoken to. In contrast, cases in which the speaker is identified by the identifier 115 as the specific user correspond to cases in which the robot 200 is spoken to by the owner. In such cases, the action controller 112 causes the robot 200 to execute an action of responding happier than in the cases in which the robot 200 is spoken to by a user other than the owner. For example, the action controller 112 rotates the twist motor 221 or the vertical motor 222 in a larger manner or outputs the animal sound by the speaker 231 at a greater volume compared to a case in which the robot 200 is spoken to by a user other than the owner. Thus, by changing the actions corresponding to cases of being spoken to by the owner and by others, it is possible to imitate the behavior of a real pet at a high level, and it is possible to improve lifelikeness.

Returning to FIG. 3, in cases in which an external stimulus that satisfies the specific condition is detected by the sensor unit 210 as the external stimulus, the condition changer 116 changes the collection condition such that sounds newly detected by the microphone 213 more easily satisfy the collection condition for a period from the detection of the external stimulus satisfying the specific condition until a predetermined amount of time elapses. Here, the specific condition is a condition that is aimed at enabling the data collector 113 to efficiently collect the sound data of the owner, and is set in advance so as to be satisfied when there is a high possibility that that owner is near the robot 200.

Specifically, the specific condition is satisfied in cases in which an event occurs in which a pet is more likely to be happy such as, for example, “spoken to”, “petted”, or the like among the plurality of events defined in the event table 121. In contrast, the specific condition is not satisfied in cases in which an event occurs in which a pet is more likely to feel uncomfortable such as, for example, “there is a loud sound”, “struck”, or the like. As such, the specific condition is satisfied in cases in which a sound is detected by the microphone 213 that has a peak value less than the first threshold TH1 and greater than or equal to the second threshold TH2, which is the occurrence condition for “spoken to.” In other words, a sound for which the peak value is within a predetermined range (from the first threshold TH1 to the second threshold TH2) satisfies the specific condition. Additionally, the specific condition is satisfied in a case in which a contact of less than a predetermined strength is detected by the touch sensor 211 of the head 204 or the torso 206, which is the occurrence condition for “petted.” In other words, a contact to the robot 200 for which the strength is less than a predetermined strength satisfies the specific condition. In contrast, the specific condition is not satisfied in cases in which the occurrence condition for “there is a loud sound” or “struck” is met.

Note that, in addition to the occurrence condition for “spoken to” or “petted” described above, the detection values detected by the acceleration sensor 212 and the gyrosensor 214 being less than or equal to a predetermined value may also be added as the specific condition. As a result, it is possible to exclude, from the specific condition, cases in which the robot 200 is spoken to or petted while being turned over or being shaken forcibly.

In cases such as described above in which the external stimulus satisfying the specific condition is detected by the sensor unit 210, there is a high possibility that the user corresponding to the owner of the robot 200 is near the robot 200. As such, the condition changer 116 relaxes the collection condition such that the features of sounds detected by the microphone 213 more easily satisfy the collection condition for the period from the detection of the external stimulus satisfying the specific condition until the predetermined amount of time elapses. The predetermined amount of time is an amount of time of a predetermined length, such as, for example, three minutes, five minutes, or the like. By relaxing the collection condition during this amount of time, it is easier to collect, as the training data 122, the sound data of the user corresponding to the owner.

Specifically, the condition changer 116 reduces the third threshold TH3 lower for the period from the detection of the external stimulus satisfying the specific condition until the predetermined amount of time elapses than in cases in which an external stimulus satisfying the specific condition is not detected (hereinafter referred to as “normal cases”). In other words, the condition changer 116 changes each of the peak threshold TH3_1 and the deviation threshold TH3_2 that are the third threshold TH3 to a value smaller than in normal cases. As a result, even in cases in which the sound data has a lower peak value and a lower deviation than in normal cases, the collection condition will be satisfied and the sound data will be collected as the training data 122 by the data collector 113. In other words, the sound data that does not satisfy the collection condition in normal cases satisfies the collection condition for the period from the detection of the external stimulus satisfying the specific condition until the predetermined amount of time elapses. As a result, it is easier to collect, as the training data 122, the sound data of the user corresponding to the owner.

Thus, due to the condition changer 116 relaxing the collection condition in cases in which an external stimulus that makes the robot 200 happy, such as “spoken to”, “petted”, or the like is detected, the identifier 115 more easily identifies the user that cares for the robot 200 as the owner. In other words, the robot 200 can imitate the behavior of a real pet, namely recognizing, as the owner, the person that takes care of the robot 200. The condition changer 116 restores the collection condition after the predetermined amount of time elapses from the detection of the external stimulus satisfying the specific condition.

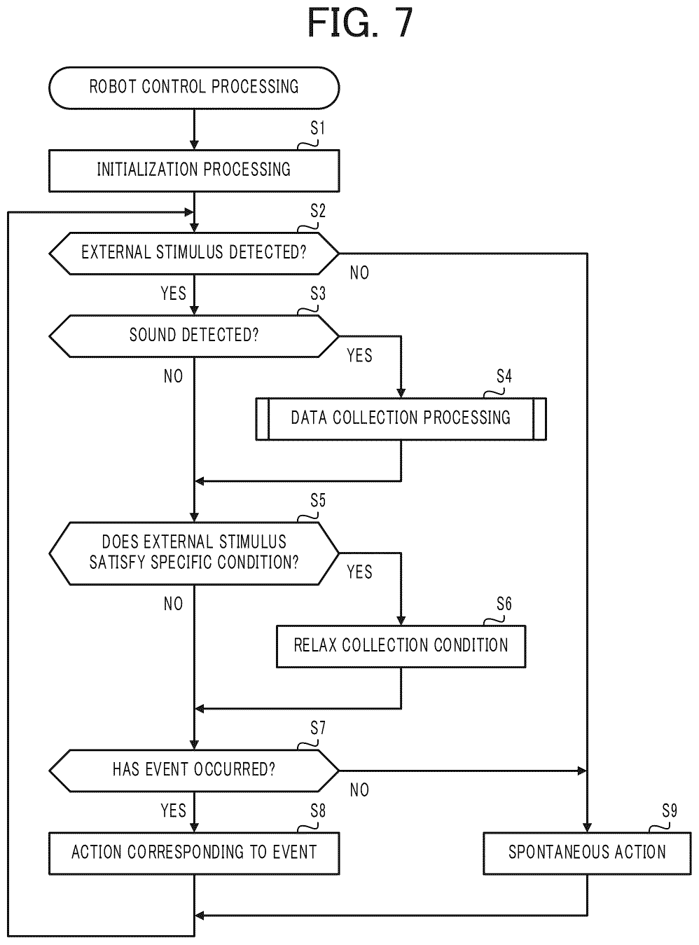

Next, the flow of robot control processing according to the present embodiment is described while referencing FIG. 7. The robot control processing illustrated in FIG. 7 is executed by the controller 110 of the control device 100, with turning ON the power of the robot 200 as a trigger. The robot control processing illustrated in FIG. 7 is an example of a robot control method. Upon starting of the robot control processing, the controller 110 executes initialization processing (step S1). In the initialization processing, the controller 110 sets the various parameters used in the control of the robot 200 to initial values. Upon execution of the initialization processing, the controller 110 determines whether some sort of external stimulus is detected by any of the touch sensor 211, the acceleration sensor 212, the microphone 213, and the gyrosensor 214 of the sensor unit 210 (step S2).

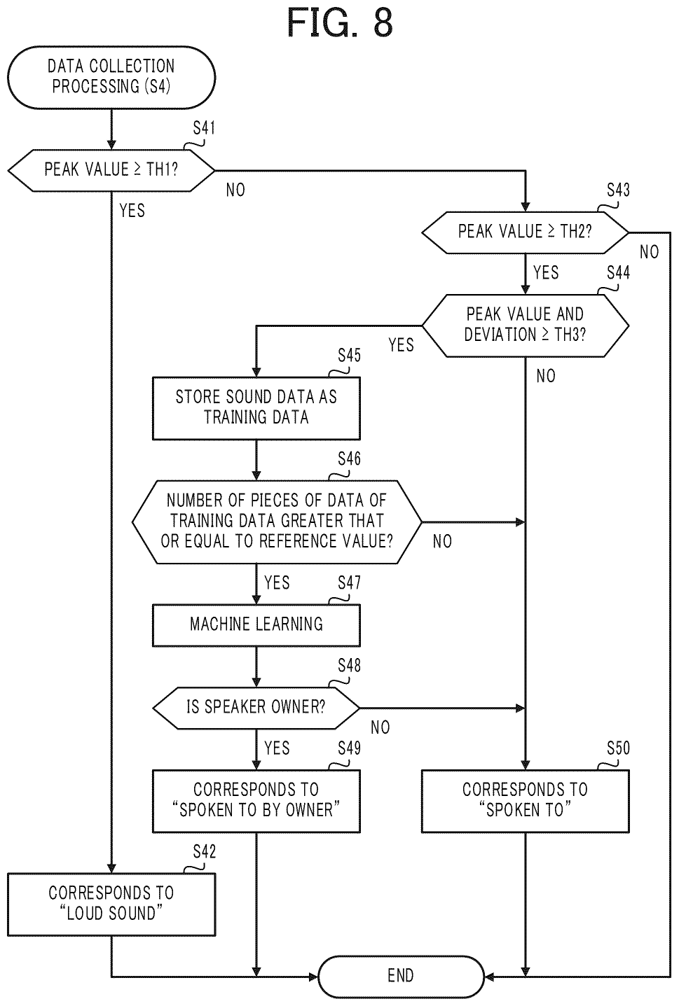

In a case in which an external stimulus is detected (step S2; YES), the controller 110 determines whether a sound is detected by the microphone 213 as the external stimulus (step S3). In a case in which a sound is detected (step S3; YES), the controller 110 executes data collection processing (step S4). Details of the data collection processing of step S4 are described while referencing FIG. 8.

Upon starting of the data collection processing illustrated in FIG. 8, the controller 110 determines whether the peak value of the sound detected in step S2 is greater than or equal to the first threshold TH1 (step S41). In a case in which the peak value is greater than or equal to the first threshold TH1 (step S41; YES), the controller 110 determines that the detected sound corresponds to a “loud sound” (step S42), and ends the data collection processing illustrated in FIG. 8.

In contrast, in a case in which the peak value is less than the first threshold TH1 (step S41; NO), the controller 110 next determines whether the peak value of the sound detected in step S2 is greater than or equal to the second threshold TH2 (step S43). In a case in which the peak value is less than the second threshold TH2 (step S43; NO), the controller 110 determines that the detected sound is noise such as an environmental sound or the like, and ends the data collection processing illustrated in FIG. 8.

In contrast, in a case in which the peak value is greater than or equal to the second threshold TH2 (step S43; YES), the controller 110 determines that the detected sound is a voice. In such a case, the controller 110 determines whether the peak value and the deviation of the detected sound are greater than or equal to the third threshold TH3 (step S44). Specifically, the controller 110 determines whether the peak value of the detected sound is greater than or equal to the peak threshold TH3_1 and, also, the deviation of the detected sound is greater than or equal to the deviation threshold TH3_2.

In a case in which the peak value and the deviation are greater than or equal to the third threshold TH3 (step S44; YES), the controller 110 determines that the detected sound is voice suitable as the training data 122. In such a case, the controller 110 functions as the data collector 113, and stores sound data expressing the detected sound as the training data 122 (step S45). In other words, the controller 110 adds and sound data expressing the detected sound as new sound data to the training data 122 and stores the data.

Upon storing of the sound data as the training data 122, the controller 110 determines whether the number of pieces of data of the training data 122 is greater than or equal to the reference value (step S46). In a case in which the number of pieces of data of the training data 122 is greater than or equal to the reference value (step S46; YES), the controller 110 functions as the trainer 114, performs the machine learning using the training data 122, and generates the trained model 123 (step S47). At this time, in a case in which a trained model 123 already exists in the storage 120, machine learning is performed using the training data 122 to which the new sound data has been added, and the trained model 123 is updated. Note that in a case in which a trained model 123 already exists in the storage 120, the controller 110 may execute the processing for generating the trained model 123 in step S47 every time new sound data is stored as the training data 122. For example, the controller 110 may be configured to perform the machine learning using the most recent training data 122 at a point at which a given number of pieces of data of the training data 122 have been collected, and update the trained model 123.

Upon performance of the machine learning, the controller 110 functions as the identifier 115, uses the trained model 123 to identify the voice that is the sound detected in step S2, and determines whether the speaker is the specific user corresponding to the owner (step S48). In a case in which the speaker corresponds to the owner (step S48; YES), the controller 110 determines that the sound detected in step S2 corresponds to “spoken to by owner” (step S49). In contrast, in a case in which the speaker does not correspond to the owner (step S48; NO), the controller 110 determines that the sound detected in step S2 corresponds to simply “spoken to” or, rather, “spoken to” by a user other than the owner (step S50).

Note that in a case in which, in step S46, the number of pieces of data of the training data 122 is less than the reference value (step S46; NO), the controller 110 determines that effective machine learning cannot be performed. In such a case, the controller 110 transitions the processing to step S50 without executing the machine learning, and determines that the sound detected in step S2 corresponds to “spoken to” by a user other than the owner. Additionally, in a case in which, in step S44, the peak value and the deviation are less than the third threshold TH3 (step S44; NO), the controller 110 determines that the sound detected in step S2 is not voice suitable as the training data 122. In such a case, the controller 110 transitions the processing to step S50 without updating the training data 122, and determines that the sound detected in step S2 corresponds to “spoken to” by a user other than the owner. Thus, the data collection processing illustrated in FIG. 8 is ended.

In contrast, returning to FIG. 7, in a case in which a sound is not detected as the external stimulus (step S3; NO), the controller 110 skips step S4. Next, the controller 110 determines whether the external stimulus detected in step S2 satisfies the specific condition (step S5). In a case in which the detected external stimulus satisfies the specific condition (step S5; YES), the controller 110 functions as the condition changer 116 and relaxes the collection condition for the predetermined amount of time (step S6). Specifically, the controller 110 reduces the third threshold TH3 more than in cases in which the external stimulus does not satisfy the specific condition. As a result, from that point in time until the predetermined amount of time elapses, in the determination processing of step S44, the peak value and the deviation of sounds newly detected by the microphone 213 will be more easily determined to be greater than or equal to the third threshold TH3. Meanwhile, in a case in which the detected external stimulus does not satisfy the specific condition (step S5; NO), the controller 110 skips step S6.

Next, the controller 110 functions as the event determiner 111 and determines whether an event based on the external stimulus has occurred (step S7). Specifically, the controller 110 determines whether the occurrence condition of any event defined in the event table 121 has been met by the external stimulus detected in step S2. In the case that an event has occurred (step S7; YES), the controller 110 functions as the action controller 112 and causes the robot 200 to execute an action corresponding to the event that occurred (step S8).

More specifically, in a case in which an external stimulus other than a sound is detected in step S2, the controller 110 causes the robot 200 to execute a corresponding action that corresponds to the event based on that external stimulus other than a sound. For example, in the case of “petted”, the controller 110 causes the robot 200 to execute a happy action. In the case of “struck”, the controller 110 causes the robot 200 to execute a sad action. In contrast, in a case in which a sound is detected in step S2, the controller 110 causes the robot 200 to execute an action corresponding to the determination result of the data collection processing of step S4. For example, in a case in which the detected sound is determined to correspond to a “loud sound” in step S42, the controller 110 causes the robot 200 to execute a surprised action. In a case in which the detected sound is determined to correspond to “spoken to” in step S50, the controller 110 causes the robot 200 to execute an action of reacting to being spoken to. Additionally, in a case in which the detected sound is determined to correspond to “spoken to by owner” in step S49, the controller 110 causes the robot 200 to execute an action of reacting to and being very happy about being spoken to.

In step S2, in a case in which an external stimulus is not detected (step S2; NO), or in a case in which an event has not occurred (step S7; NO), the controller 110 functions as the action controller 112 and causes the robot 200 to execute a spontaneous action (step S9). The spontaneous action is an action that the robot 200 executes spontaneously regardless of external stimuli. Examples of the spontaneous action include a breathing action expressing pseudo-breathing, actions of randomly moving the body, and the like. In a case in which an external stimulus is not detected by any of the plurality of sensors of the sensor unit 210, the controller 110 causes the robot 200 to execute the spontaneous action at a timing of, for example, once every few seconds.

Thereafter, the controller 110 returns to step S2. The controller 110 repeats the processing of steps S2 to S9 for as long as the power of the robot 200 is turned ON and the robot 200 is able to operate normally. As a result, in a case in which sound satisfying the collection condition is detected, the controller 110 repeats the processing of collecting, as the training data 122, sound data expressing the detected sound.

As described above, in cases in which a sound satisfying the predetermined collection condition is detected, the robot 200 according to Embodiment 1 stores sound data expressing the detected sound as the training data 122, and changes the collection condition such that it that sounds detected by the sensor unit 210 more easily satisfy the collection condition for the period from the detection of the external stimulus satisfying the specific condition until the predetermined amount of time elapses. Due to this configuration, with the robot 200 according to Embodiment 1, it is easier to collect the sound data in cases in which there is a high possibility that the user corresponding to the owner is near the robot 200, and sound data of the specific user corresponding to the owner can be efficiently collected as training data.

Next, Embodiment 2 is described. In Embodiment 2, as appropriate, descriptions of configurations and functions that are the same as described in Embodiment 1 are forgone. In Embodiment 1, the robot 200 is provided with the functions of the data collector 113, the trainer 114, and the condition changer 116. In contrast, in Embodiment 2, a training data collection device 300 is provided with these functions. The training data collection device 300 is a device outside the robot 200 and is independent from the robot 200. In one example, the training data collection device 300 is an information processing device such as a general-use personal computer, a tablet terminal, a smartphone, or the like.

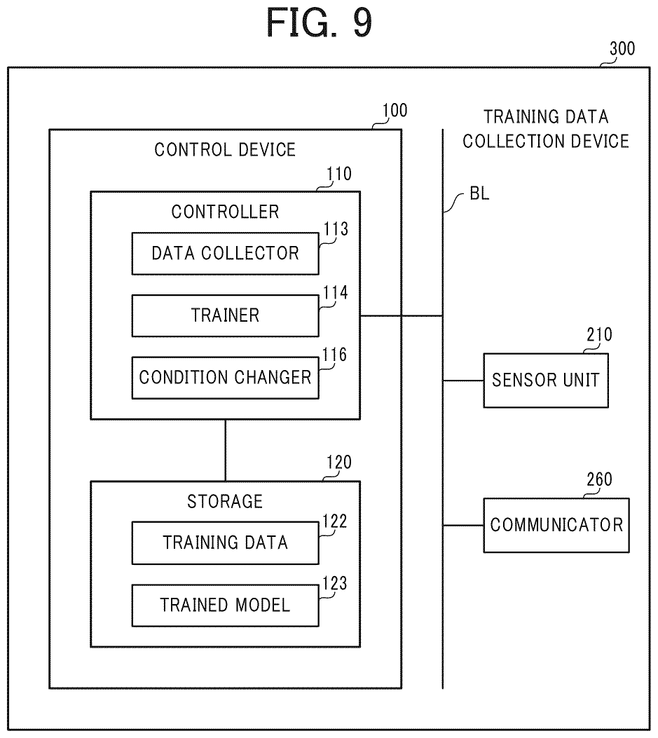

Specifically, as illustrated in FIG. 9, the training data collection device 300 according to Embodiment 2 includes a sensor unit 210, a communicator 260, and a control device 100. As with the sensor unit 210 of the robot 200, the sensor unit 210 of the training data collection device 300 includes a touch sensor 211, an acceleration sensor 212, a microphone 213, and a gyrosensor 214. The communicator 260 includes a communication interface for communicating with external devices of the training data collection device 300. In one example, the communicator 260 communicates with external devices including the robot 200 in accordance with a device communication standard such as a wireless local area network (LAN), Bluetooth Low Energy (BLE, registered trademark), Near Field Communication (NFC), or the like.

The training data collection device 300 functionally includes, in the controller 110 of the control device 100, a data collector 113, a trainer 114. and a condition changer 116. These components are the same as the components of the robot 200 in Embodiment 1. Specifically, the data collector 113 stores, in the storage 120 and as the training data 122, sound data expressing sounds that satisfy the predetermined collection condition among the sounds detected by sensor unit 210. The condition changer 116 changes the collection condition such that the sounds newly detected by the microphone 213 more easily satisfy the collection condition for the period from the detection of the external stimulus satisfying the specific condition until the predetermined amount of time elapses. The trainer 114 performs machine learning on the basis of the training data 122 collected by the data collector 113, and generates the trained model 123. Additionally, upon generation of the trained model 123, the trainer 114 communicates with the robot 200 via the communicator 260 and sends the generated trained model 123 to the robot 200.

While not illustrated in the drawings, the robot 200 according to Embodiment 2 includes, in the controller 110 of the control device 100, the event determiner 111, the action controller 112, and the identifier 115, but does not include the data collector 113, the trainer 114, and the condition changer 116. The event determiner 111 and the action controller 112 are the same as described in Embodiment 1. The robot 200 communicates with the training data collection device 300 via a non-illustrated communicator, and acquires the trained model 123 from the training data collection device 300. Moreover, the identifier 115 uses the trained model 123 acquired from the training data collection device 300 to identify the speaker of the voice detected by the sensor unit 210.

Thus, in Embodiment 2, the robot 200 does not include the data collector 113, the trainer 114, and the condition changer 116, and the training data collection device 300, which is a device different than the robot 200, collects the training data 122 and generates the trained model 123 on the basis of the collected training data 122. As a result, the configuration of the robot 200 can be made simpler than in Embodiment 1. Additionally, by sending the trained model 123 generated by the training data collection device 300 to a plurality of robots 200, the plurality of robots 200 can be enabled to accurately identify the speaker from a sound.

Embodiments of the present disclosure are described above, but these embodiments are merely examples and do not limit the scope of application of the present disclosure. That is, various applications of the embodiments of the present disclosure are possible, and all embodiments are included in the scope of the present disclosure. For example, in the embodiments described above, the trainer 114 performs machine learning using a clustering method to generate the trained model 123. However, the method used is not limited to clustering, and a configuration is possible in which the trainer 114 performs the machine learning using a different method such as principal component analysis or the like.

In the embodiments described above, the collection condition for the data collector 113 to collect the training data 122 is defined by three thresholds TH1 to TH3. However, the collection condition is not limited thereto, and any condition may be defined. For example, the third threshold TH3 is not limited to the peak threshold TH3_1 and the deviation threshold TH3_2, and a configuration is possible in which the third threshold TH3 is defined by a threshold for a different feature quantity of the sound. Additionally, cases in which at least feature quantity is greater than or equal to the third threshold TH3, may be cases in which the at least one feature quantity is a value within a predetermined range. In such a case, a configuration is possible in which the condition changer 116 changes the collection condition such that the features of sounds more easily satisfy the collection condition due to the predetermined range being widened for the period from the detection of the external stimulus satisfying the specific condition until the predetermined amount of time elapses.

In the embodiment described above, the exterior 201 is formed in a barrel shape from the head 204 to the torso 206, and the robot 200 has a shape as if lying on its belly. However, the robot 200 is not limited to resembling a living creature that has a shape as if lying on its belly. For example, a configuration is possible in which the robot 200 has a shape provided with arms and legs, and resembles a living creature that walks on four legs or two legs.

In the embodiment described above, the control device 100 is installed in the robot 200, but a configuration is possible in which the control device 100 is not installed in the robot 200 but, rather, is a separated device (for example, a server). When the control device 100 is provided outside the robot 200, the robot 200 and the control device 100 communicate and exchange data with each other via communicators. The control device 100 controls the robot 200 via communication with the robot 200. In Embodiment 2, the training data collection device 300 includes the data collector 113, the trainer 114, and the condition changer 116, but a configuration is possible in which the trainer 114 is provided to a device other than the training data collection device 300. In other words, the data collector 113 and the trainer 114 are not limited to being provided to the same device and may be provided to separate devices.

In the embodiment described above, in the controller 110, the CPU executes programs stored in the ROM to function as the various components, namely, the event determiner 111, the action controller 112, the data collector 113, the trainer 114, the identifier 115, and the condition changer 116. However, in the present disclosure, the controller 110 may include, for example, dedicated hardware such as an Application Specific Integrated Circuit (ASIC), a Field-Programmable Gate Array (FPGA), various control circuitry, or the like instead of the CPU, and this dedicated hardware may function as the various components. In this case, the functions of each of the components may be realized by individual pieces of hardware, or the functions of each of the components may be collectively realized by a single piece of hardware. Additionally, the functions of each of the components may be realized in part by dedicated hardware and in part by software or firmware.

It is possible to provide a robot or a training data collection device, provided in advance, with the configurations for realizing the functions according to the present disclosure, but it is also possible to apply a program to cause an existing information processing device or the like to function as the robot or the training data collection device according to the present disclosure. That is, a configuration is possible in which a CPU or the like that controls an existing information processing device or the like is used to execute a program for realizing the various functional components of the robot 200 or the training data collection device 300 described in the foregoing embodiments, thereby causing the existing information processing device to function as the robot or the training data collection device according to the present disclosure.

Additionally, any method may be used to apply the program. For example, the program can be applied by storing the program on a non-transitory computer-readable recording medium such as a flexible disc, a compact disc (CD) ROM, a digital versatile disc (DVD) ROM, and a memory card. Furthermore, the program can be superimposed on a carrier wave and applied via a communication medium such as the internet. For example, the program may be posted to and distributed via a bulletin board system (BBS) on a communication network. Moreover, a configuration is possible in which the processing described above is executed by starting the program and, under the control of the operating system (OS), executing the program in the same manner as other applications/programs.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A robot comprising:
a sensor that detects an external stimulus; and
at least one processor, wherein
in response to detection, by the sensor and as the external stimulus, of a sound that satisfies a predetermined collection condition, the at least one processor stores sound data expressing the detected sound in a storage device as training data for identifying a speaker from the sound, and
in response to detection by the sensor of an external stimulus that satisfies a specific condition, the at least one processor changes the collection condition such that the sound detected by the sensor more easily satisfies the collection condition for a period from the detection of the external stimulus satisfying the specific condition until a predetermined amount of time elapses.

2. The robot according to claim 1, wherein
the collection condition includes that at least one feature quantity of the sound detected by the sensor is greater than or equal to a threshold, and
the at least one processor reduces the threshold for the external stimulus satisfying the specific condition, for the period from the detection, by the sensor, of the external stimulus satisfying the specific condition until the predetermined amount of time elapses.

3. The robot according to claim 1, wherein a sound, detected as the external stimulus by the sensor, having a peak value within a predetermined range satisfies the specific condition.

4. The robot according to claim 1, wherein a contact, detected as the external stimulus by the sensor, having a contact strength less than a predetermined strength satisfies the specific condition.

5. The robot according to claim 1, wherein in response to detection, by the sensor and as the external stimulus, of the sound that satisfies the predetermined collection condition, the at least one processor uses a trained model generated by machine learning to identify the speaker from the detected sound.

6. The robot according to claim 5, wherein in response to the speaker being identified to be a specific user, the at least one processor causes the robot to execute an action that is different than an action to be executed in response to the speaker being identified as a user other than the specific user.

7. The robot according to claim 5, wherein in response to a number of pieces of data stored as the training data being greater than or equal to a reference value, the at least one processor generates the trained model by performing the machine learning based on the training data.

8. The robot according to claim 7, wherein the at least one processor performs the machine learning by using a clustering method,

9. The robot according to claim 7, wherein the at least one processor restores the collection condition after the predetermined amount of time elapses.

10. A training data collection method executed by a training data collection system provided with a sensor for detecting an external stimulus, the method comprising:
in response to detection, by the sensor and as the external stimulus, of a sound that satisfies a predetermined collection condition, storing sound data expressing the detected sound in a storage device as training data for identifying a speaker from the sound; and
in response to detection by the sensor of an external stimulus that satisfies a specific condition, changing the collection condition such that the sound detected by the sensor more easily satisfies the collection condition for a period from the detection of the external stimulus satisfying the specific condition until a predetermined amount of time elapses.

11. The training data collection method according to claim 10, wherein
the collection condition includes that at least one feature quantity of the sound detected by the sensor is greater than or equal to a threshold, and
in response to detection by the sensor of an external stimulus that satisfies a specific condition, the threshold is reduced for the period from the detection, by the sensor, of the external stimulus satisfying the specific condition until the predetermined amount of time elapses.

12. The training data collection method according to claim 10, wherein a sound, detected as the external stimulus by the sensor, having a peak value within a predetermined range satisfies the specific condition.

13. The training data collection method according to claim 10, wherein a contact, detected as the external stimulus by the sensor, having a contact strength less than a predetermined strength satisfies the specific condition.

14. The training data collection method according to claim 10, wherein the collection condition is restored after the predetermined amount of time elapses.

15. The training data collection method according to claim 10, wherein
the training data collection system includes
a robot provided with the sensor, and
a server capable of communicating with the robot.

16. A non-transitory recording medium storing a program readable by a computer of a training data collection system including a sensor for detecting an external stimulus, the program causing the computer to realize:
a first function of, in response to detection, by the sensor and as the external stimulus, of a sound that satisfies a predetermined collection condition, storing sound data expressing the detected sound in a storage device as training data for identifying a speaker from the sound; and
a second function of, in response to detection by the sensor of an external stimulus that satisfies a specific condition, changing the collection condition such that the sound detected by the sensor more easily satisfies the collection condition for a period from the detection of the external stimulus satisfying the specific condition until a predetermined amount of time elapses.

17. The non-transitory recording medium according to claim 16, wherein
the collection condition includes that at least one feature quantity of the sound detected by the sensor is greater than or equal to a threshold, and
in response to detection by the sensor of an external stimulus that satisfies a specific condition, the second function reduces the threshold for the period from the detection of the external stimulus satisfying the specific condition until the predetermined amount of time elapses.

18. The non-transitory recording medium according to claim 16, wherein a sound, detected as the external stimulus by the sensor, having a peak value within a predetermined range satisfies the specific condition.

19. The non-transitory recording medium according to claim 16, wherein a contact, detected as the external stimulus by the sensor, having a contact strength less than a predetermined strength satisfies the specific condition.

20. The non-transitory recording medium according to claim 16, wherein the second function restores the collection condition after the predetermined amount of time elapses.
